(19) United States
(12) Patent Application Publication
(10) Pub. No.: US 2019/0065132 A1
(43) Pub. Date: Feb. 28, 2019

(54) CONTENT DISTRIBUTION DEVICE, CONTENT DISTRIBUTION SYSTEM, AND STORAGE MEDIUM

(71) Applicant: SHARP KABUSHIKI KAISHA, Sakai City (JP)

(72) Inventor: YUUKI MASUI, Sakai City (JP)

(21) Appl. No.: 16/106,569

(22) Filed: Aug. 21, 2018

(30) Foreign Application Priority Data
Aug. 24, 2017 (JP) 2017-161406

(51) Int. Cl. G06F 3/14; G06F 3/147

(52) U.S. Cl. CPC G06F 3/1431; G06F 3/147; G06F 3/1446

(57) ABSTRACT

Display device information on a display device connected to a content distribution device is managed, and summary information is generated and displayed in accordance with the display device information. In a case where the displayed summary information is selected, display devices corresponding to the selected summary information are extracted, and the content is distributed to the extracted display devices.

### BACKGROUND

### 1. Field

The present disclosure relates to a content distribution device and the like.

### 2. Description of the Related Art

In recent years, digital signage is widely used. In the digital signage, a display device is disposed in a place where there are many people, such as a station or a shopping center, and contents such as advertisements are displayed on the display device.

Since a lot of display devices are installed in digital signage in the facility as described above, the number of display devices managed by an administrator becomes very large, for example, the number may be several thousands. In a case where there are many display devices to be managed, in order to improve the efficiency of management (of the status of each display device, the status as to whether a content has been normally distributed, and the like), a mechanism for managing respective display devices in groups is proposed.

However, even if the display devices are managed on a group-by-group basis, when the number of display devices reaches thousands of units, the number of display devices belonging to each group also increases, which is a burden on checking the status of all the display devices.

On the other hand, other than in digital signage, a method of displaying the status of devices on a folder tree is suggested. For example, Japanese Unexamined Patent Application Publication No. 2015-133067 discloses an information processing device in which a transmission history of a facsimile machine is displayed in the form of a folder tree. The information processing device classifies transmission history data of the facsimile machine in accordance with the status such as “transmission successful”, “transmission failed”, “processing”, or “canceled” and displays the results as a folder tree. In addition, for example, it is possible to narrow down and check the transmission history data, whose transmission has failed, of the facsimile machine by selecting the folder with “transmission failed” in the folder tree.

As described above, although the technique which collectively displays the status of a device is disclosed, the status of the device is merely displayed. For example, when a problem arises, the device is desired to individually deal with the problem.

In addition, in the case of the display device of the digital signage, since the installed display devices may exist in the whole country, and thus, for example, there are cases where groups are formed for respective areas. In such cases, it is desired to display the status for each area and specify redistribution of content according to the status, but such desire has not been taken into account in the related art.

It is desirable to provide a content distribution system or the like in which a content is efficiently distributed by using a summary based on information on a display device.

### SUMMARY

A content distribution device of the present disclosure is connectable to one or more display devices that display a content. The content distribution device includes a display-device-information management unit that manages display device information on the one or more display devices connected to the content distribution device, a summary information generation unit that generates summary information based on the display device information on the one or more display devices, a display unit that displays the summary information, a display device extraction unit that extracts one or more display devices corresponding to selected summary information in a case where the displayed summary information is selected, a distribution destination determination unit that determines a di y device to be a distribution destination of the content from the one or more display devices extracted by the display device extraction unit, and a content distribution unit that distributes the content to the display device determined by the distribution destination determination unit.

A content distribution system of the present disclosure includes one or more display devices and a content distribution device. The content distribution device includes a display-device-information management unit that manages display device information on the one or more display devices connected to the content distribution device, a summary information generation unit that generates summary information based on the display device information, a display unit that displays the summary information, a display device extraction unit that extracts one or more display devices corresponding to selected summary information in a case where the displayed summary information is selected, a distribution destination determination unit that determines a display device to be a distribution destination of the content from the one or more display devices extracted by the display device extraction unit, and a content distribution unit that distributes the content to the display device determined by the distribution destination determination unit, and the content display device includes a content reception unit that receives the content distributed from the content distribution device, and a content display unit that displays the received content.

A non-transitory storage medium storing a program of the present disclosure causing a computer connectable to one or more display devices that display a content to execute a display-device-information management function of managing display device information on the one or more display devices connected to the content distribution device, a summary information generation function of generating summary information based on the display device information on the one or more display devices, a display function of displaying the summary information, a display device extraction function of extracting one or more display devices corresponding to selected summary information in a case where the displayed summary information is selected, a distribution destination determination function of determining a display device to be a distribution destination of the content from the one or more display devices extracted by the display device extraction function, and a content distribution function of distributing the content to the display device determined by the distribution destination determination function.

### BRIEF DESCRIPTION OF THE DRAWINGS

FIG. 1 is a diagram for describing an overview of a content distribution system in a first embodiment;

FIG. 2 is a diagram for describing a functional configuration of a content distribution device according to the first embodiment;

FIG. 3A is a diagram for describing a play list, and FIG. 3B is a diagram for describing panel management information in the first embodiment;

FIG. 4 is a diagram for describing a summary type in the first embodiment;

FIG. 5 is a diagram for describing a functional configuration of a display device in the first embodiment.

FIG. 6 is a diagram for describing summary information display processing in the first embodiment;

FIG. 7 is a diagram for describing content distribution processing in the first embodiment;

FIG. 8 is a diagram for describing an operation example (summary information display processing) in the first embodiment;

FIG. 9 is a diagram for describing an operation example (content distribution processing) in the first embodiment;

FIG. 10 is a diagram for describing an operation example (content distribution processing) in the first embodiment;

FIG. 11 is a diagram for describing an operation example (content distribution processing) in the first embodiment;

FIG. 12 is a diagram for describing an operation example (content distribution processing) in the first embodiment;

FIG. 13 is a diagram for describing an operation example (content distribution processing) in the first embodiment;

FIG. 14 is a diagram for describing an operation example (content distribution processing) in the first embodiment;

FIGS. 15A, 15B, and 15C are diagrams for describing an operation example (content distribution processing) in the first embodiment;

FIGS. 16A, 16B, and 16C are diagrams for describing an operation example (content distribution processing) in the first embodiment;

FIGS. 17A and 17B are diagrams for describing an operation example of a second embodiment;

FIG. 18 is a diagram for describing a summary type in a third embodiment;

FIG. 19 is a diagram for describing an operation example of the third embodiment;

FIG. 20 is a diagram for describing an operation example of the third embodiment;

FIG. 21 is a diagram for describing an operation example of the third embodiment;

FIG. 22 is a diagram for describing an operation example of the third embodiment; and

FIGS. 23A and 23B are diagrams for describing an operation example of the third embodiment.

### DESCRIPTION OF THE EMBODIMENTS

Hereinafter, embodiments of the present disclosure will be described with reference to drawings. In the embodiments, as an example, a content distribution system including a content distribution device according to the present disclosure will be described.

### 1. First Embodiment

### 1.1 Overall Configuration

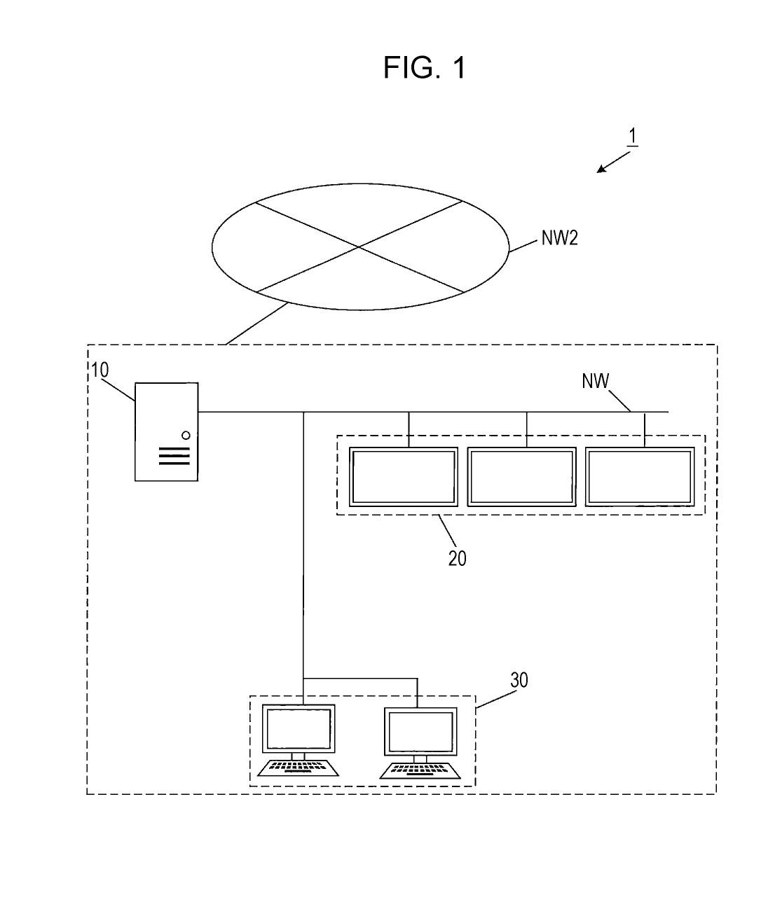

First, the overall configuration of a content distribution system 1 of the present embodiment will be described with reference to FIG. 1. As illustrated in FIG. 1, the content distribution system 1 is connected to a content distribution device 10, one or more display devices 20, and one or more terminal devices 30 via a network NW. In addition, the content distribution device 10 is connected to an external network NW 2. As the network NW, for example, a local area network (LAN) or the like is assumed, and as the external network NW 2, for example, the Internet or the like is assumed.

The content distribution device 10 is a device that manages one or more display devices 20 connected to the network NW and distributes the content to the one or more display devices 20. For example, the content distribution device 10 provides a function for checking registration or distribution of contents provided by content providers, information providers, and advertisement distributors and the status of the display device 20 under management.

The display device 20 is a device that displays the content distributed from the content distribution device 10 and is also referred to as a panel.

The terminal device 30 may be, for example, a device such as a computer or an information processing device such as a smartphone or a tablet. That is, any terminal device that may connect to the content distribution device 10, check summary information, or designate the distribution of the content is acceptable.

Here, the content referred to in the present embodiment is a still image, a moving image, a voice, a character, or the like and is a content that the display device 20 may output. The moving image may be a file of any moving image format such as Audio Video Interleave (AVI), Windows Media Video (WMV), MPEG, or the like. In addition, the still image may be a file of any image format such as JPEG, Portable Network Graphics (PNG), Graphics Interchange Format (GIF), or the like.

### 1.2 Functional Configuration

### 1.2.1 Content Distribution Device

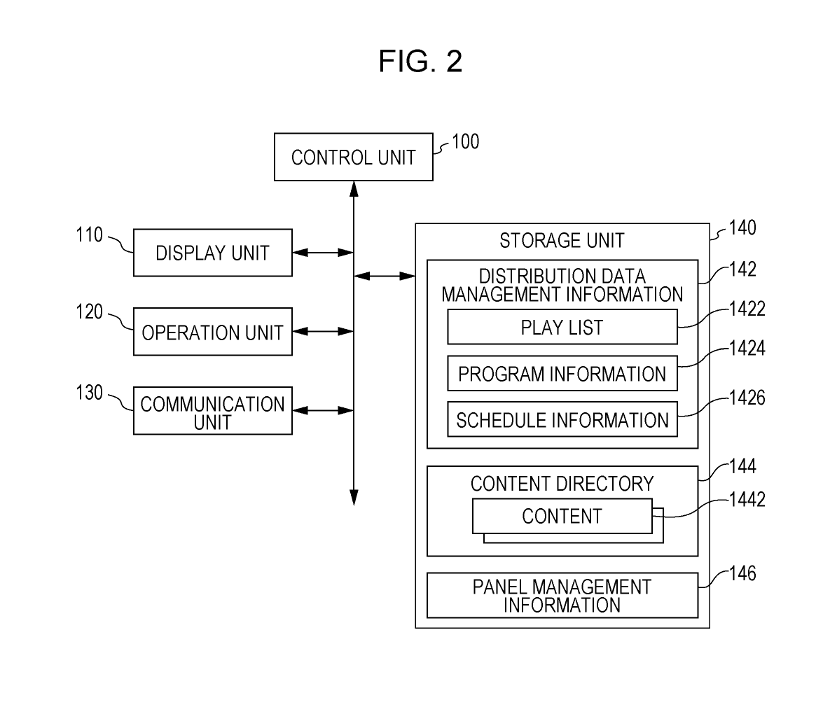

A functional configuration of the content distribution device 10 according to the present embodiment will be described with reference to FIG. 2. As illustrated in FIG. 2, the content distribution device 10 includes a control unit 100, a display unit 110, an operation unit 120, a communication unit 130, and a storage unit 140.

The control unit 100 is a functional unit for controlling the entire content distribution device 10. The control unit ion realizes various functions by reading and executing various programs stored in the storage unit 140 and is configured by, for example, a central processing unit (CPU) or the like.

The display unit 110 is a functional unit that displays a screen for registering a content and checking The status of the display device 20 under management. For example, the display unit 110 is constituted by a liquid crystal display (LCD), an organic EL display (OLED), an LED screen or the like.

The operation unit 120 is a functional unit that an operator such as an administrator of the content distribution system inputs instructions and the like, and for example, may be constituted by a mouse, a keyboard, or the like connected to the content distribution device 10, or may be integrated with the display unit 110 as a touch panel.

The communication unit 130 is a functional unit for communicating with other devices. For example, the communication unit 130 may be a functional unit that may communicate via a wired LAN or a functional unit that may communicate via a wireless LAN. The communication system may be Ethernet (registered trademark) , IEEE802.11a/b/g/n, or a communication network such as LTE (registered trademark) communication network or WiMAX (registered trademark).

The storage unit 140 is a functional unit in which various data usable for the operation of the content distribution device 10 is stored. The storage unit 140 is constituted by, for example, a solid state drive (SSD) as a semiconductor memory, a hard disk drive (HDD), or the like.

Here, in the storage unit 140, distribution data management information 142 and panel management information 146 are stored. In addition, a content directory 144 in which a content 1442 is stored exists in the storage unit 140.

In the distribution data management information 142, information for managing distribution data distributed to the display device 20 (panel) is stored. The distribution data management information 142 stores a play list 1422, program information 1424, and schedule information 1426.

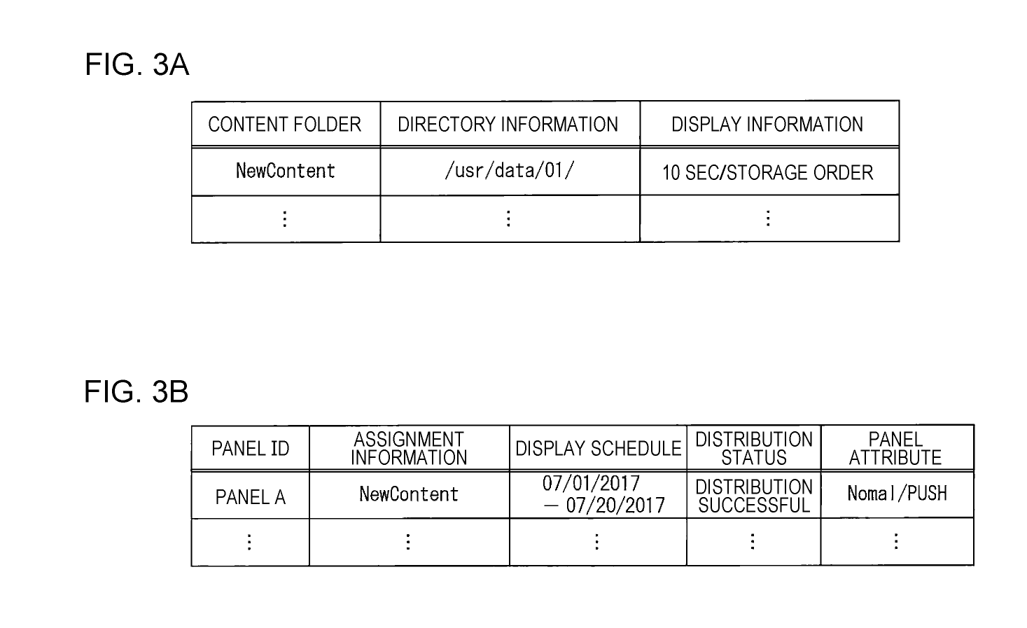

The play list 1422 is information for managing as a content folder a link of the directory storing the content distributable to the display device 20. As illustrated in FIG. 3A, the play list 1422 stores a content folder (for example, “NewContent”) as a name for uniquely identifying the information stored in the play list, directory information (for example, “/usr/data/01/”) indicating the directory of the content directory 144 in which the content is stored, and display information (for example, “every 10 sec/storage order”) indicating a display method and status of the content stored in the directory.

The program information 1424 stores settings relating to display, such as display order and display position of the content identified by a program name. For example, in a layout frame in which a display screen is divided into one or more display areas, one piece of program information is generated by specifying a content folder or content or specifying a display time and the like. The display device 20 displays the content according to the program information.

The schedule information 1426 is information indicating timing at which content or the like is displayed in accordance with the content, the content folder, and the program information. The program information 1424 and the schedule information 1426 are generated as appropriate.

The content directory 144 is provided for storing the content 1442 (actual file) to be displayed on the display device 20. In the present embodiment, the expression “directory” is used as the area for storing an actual file, and the directory is identified by a directory name. For example, contents (still image files) such as “0.1jpg” and “02.jpg” are stored in the directory identified by the directory name “/usr/data/01/”.

The directory is an area in which an actual file is stored as compared with a content folder collecting two or more contents described above. Therefore, as described above, the directory may indicate a storage location in a computer or a cloud server or may be a virtual directory generated in one file.

In the panel management information 146, information on the display device 20 managed by the content distribution device 10 is stored. The panel management information 146 will be described with reference to FIG. 3B. The panel management information 146 stores a panel ID (for example, “Panel A”) for identifying the display device 20, assignment information (for example, “NewContent”) indicating a play list or program distributed (assigned) to the display device 20 specified by the and ID, a display schedule (for example, “07/01/2017 to 07/20/2017”) defining a period for displaying the play list or the program specified by the assignment information, a distribution status indicating the distribution status (for example, “distribution successful”) of the display device 20 specified by the panel ID and a panel attribute (for example, “Normal/PUSH”) indicating the attribute of the display device 20 specified by the panel ID.

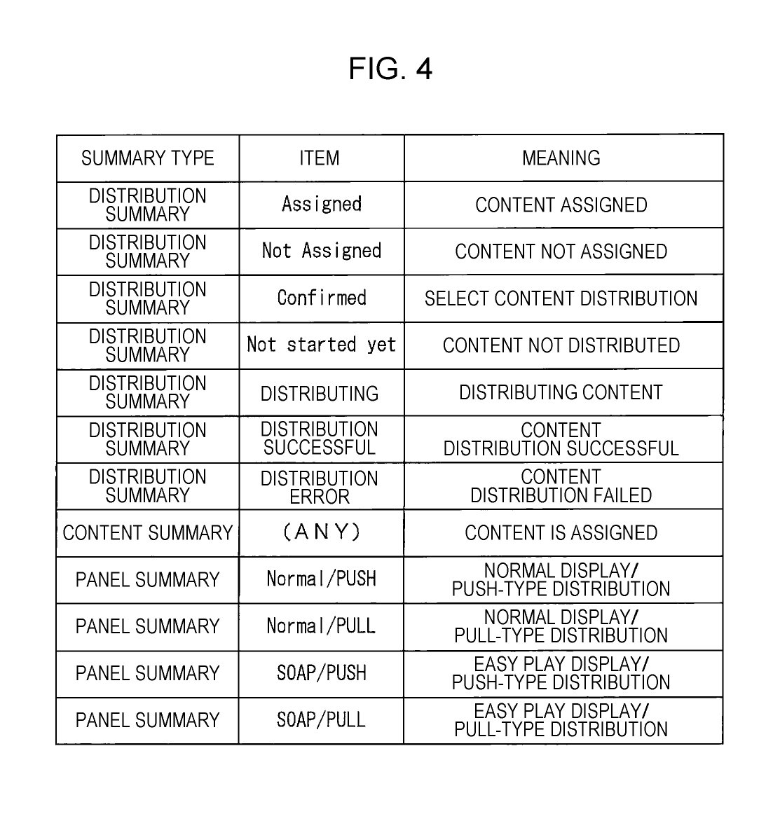

Here, FIG. 4 illustrates items assigned to a distribution status and a panel attribute. In the distribution status of the panel management information 146, any item (for example, “distributing” or “distribution error”) whose summary type is “distribution summary” is stored. In addition, as the panel attribute, any item (for example, “Normal/PUSH” or “SOAP/PUSH”) whose summary type is “panel summary” is stored.

The meanings of the items stored in the distribution status and the panel attribute are shown in the meaning column of FIG. 4. For example, in the panel management information 146, if the distribution status of the display device 20 whose panel ID is “Panel A” is “Assigned”, for the display device 20 specified by “Panel A”, the distribution status indicates that “content has been assigned”.

That is, in the example of FIG. 3B, the display device 20 whose panel ID is “panel A” displays the content of the content folder “NewContent” from Jul. 1, 2017 to Jul. 20, 2017 and indicates that the content has been successfully distributed.

### 1.2.2 Display Device

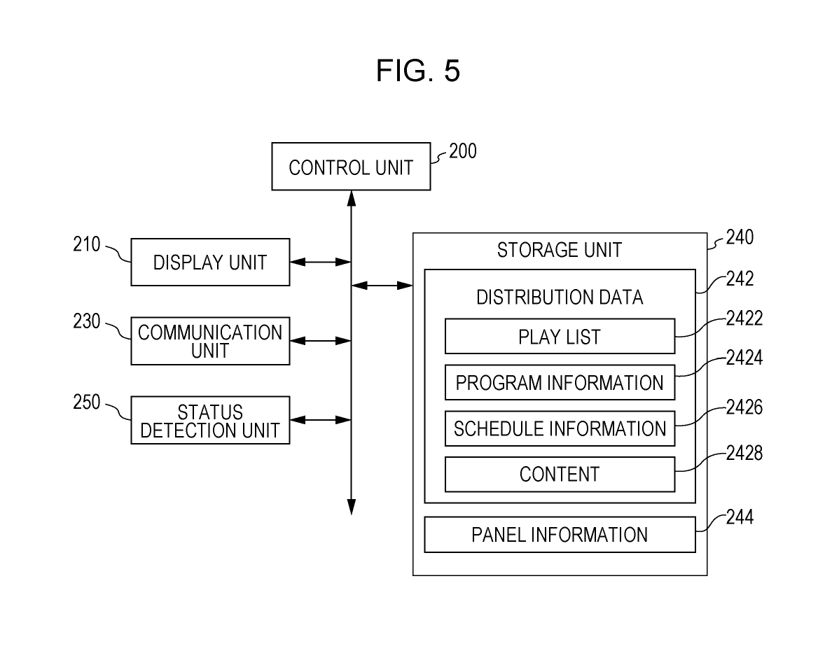

The functional configuration of the display device 20 in the present embodiment will be described with reference to FIG. 5. The display device 20 is a set of a system that performs actual display at an installation location as digital signage and is constituted by a control unit 200, a display unit 210, a communication unit 230, a storage unit 240, and a status detection unit 250.

The present embodiment will be described as the display device 20 but may be constituted by connecting a control device to a simple display panel with HDMI (registered trademark) or the like, for example. In addition, the present embodiment may be constituted as a single unit by the display device 20 equipped with a play function.

The control unit 200 is a functional unit for controlling the entire display device 20. The control unit 200 realizes various functions by reading and executing various programs stored in the storage unit 240 and is configured by, for example, a central processing unit (CPU) or the like.

The display unit 210 is a functional unit that displays contents based on distribution data 242 to be described later. For example, the display unit 210 is constituted by a liquid crystal display (LCD), an organic EL display (OLED), an LED screen, or the like.

The communication unit 230 is a functional unit for communicating with other devices. For example, the communication unit 230 may be a functional unit that may communicate via a wired LAN or a functional unit that may communicate via a wireless LAN. The communication system may be Ethernet (registered trademark), IEEE802.11a/b/g/n, or a communication network such as LTE (registered trademark) communication network or WiMAX (registered trademark).

The storage unit 240 is a functional unit in which various data usable for the operation of the display device 20 is stored. The storage unit 240 is configured by, for example, a semiconductor memory (SSD), a hard disk drive (HDD), or the like. In addition, an external storage device such as a USE memory may be connected.

Here, in the storage unit 240, distribution data 242 and panel information 244 are stored. In addition, in the distribution data 242, a play list 2422, program information 2424, schedule information 2426, and a content 2428 distributed from the content distribution device 10 are stored.

Distribution data distributed from the content distribution device 10 is stored as distribution data 242. Here, the play list 1422 distributed (transmitted) and received from the content distribution device 10 is stored in the play list 2422, the program information 1424 is stored in the program information 2424, and the schedule information 1426 is stored in the schedule information 2426, respectively.

In addition, the distribution data includes one or more contents. These contents are stored as the content 2428. The content 2428 may be stored as the distribution data 242 or may be stored in a directory that stores a predetermined content of the display device 20.

In addition, the play list, the program information, and the schedule information are optional and are not necessarily included in the distribution data. In a case where there is such information, the content is displayed according to the information. However, even if these pieces of information are not included in the distribution data, the content may be repeatedly di played at every set time, for example.

In addition, in a case where the content has already been distributed or the content stored in advance in the display device 20 is used, the content may not be included in the distribution data. In this case, the content stored in the display device 20 may be used in accordance with the play list, the program information, and the schedule information.

That is, the information included in the distribution data may be distributed from the content distribution device 10 to the display device 20 as appropriate.

The panel information 244 stores display device information that is information on the display device 20, and for example, the status of the power supply of the display device 20 detected by the status detection unit 250, and contents such as a communication error and a distribution error are stored. Furthermore, the panel information 244 may be information usable for is playing as digital signage. For example, a panel ID, the IP address of the content distribution device 10, information on the installation location, and the like are stored.

The display device 20, for example, may be constituted by a computer and a display, or may be integrated as a system. In addition, for example, the display device 20 may be realized by a display device such as a smartphone or a tablet.

The status detection unit 250 is a functional unit for detecting various statuses of the display device 20 as information on the display device 20 and storing the statuses in the panel information 244. For example, by detecting the power supply status of the display device 20, the power supply status is stored in the panel information 244, and by detecting the network error of the display device 20, distribution errors and the like are stored in the panel information 244. In addition, it may be detected and output that the display device 20 is likely to be in trouble or that various troubles are occurring.

### 1.3 Processing Flow

### 1.3.1 Summary Display Processing

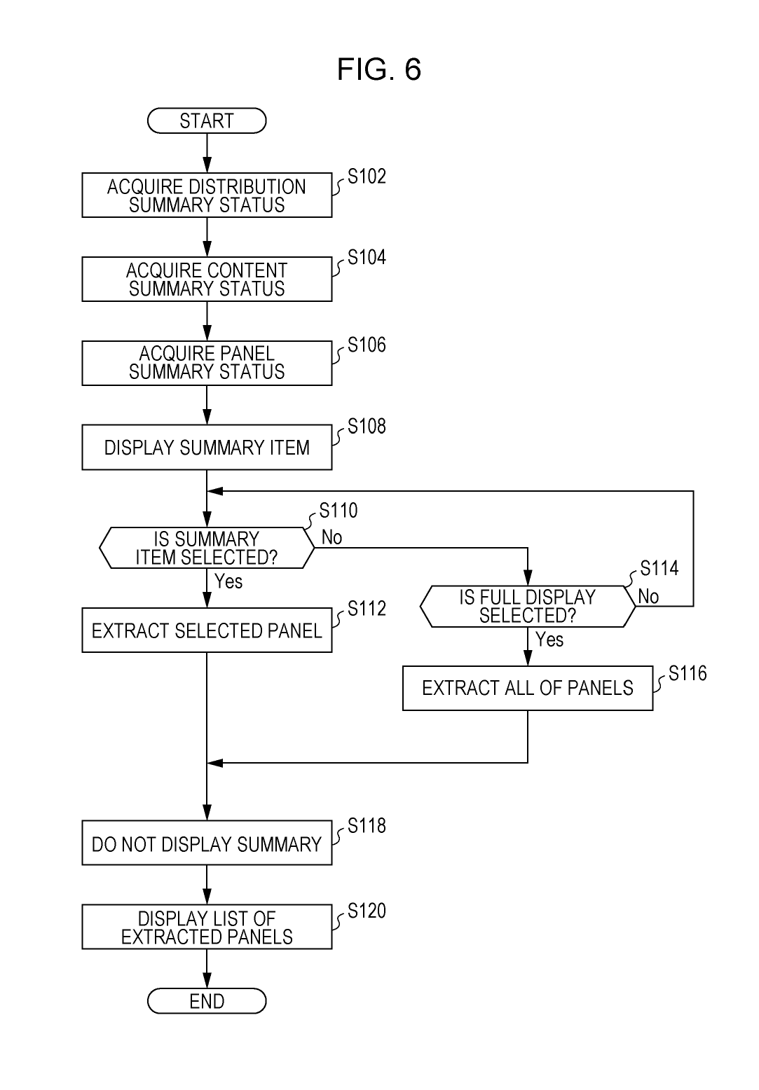

The summary display processing executed in the content distribution device 10 in the present embodiment will be described with reference to FIG. 6. The summary display is processing of performing display for checking the status of the display device 20 connected to the content distribution device 10. The processing result of the processing realized by the content distribution device 10 is displayed on the display unit 110 of the content distribution device 10 or the terminal device 30 connected to the content distribution device 10. In the following description, the display device 20 is referred to as a panel.

First, in order to easily check the display device information on the display device 20, the summary status is acquired. In the present embodiment, the distribution summary status is acquired (step S102), the content summary status is acquired (step S104), and the panel summary status is acquired (step S106).

The distribution summary is a summary of the distribution status such as whether or not the distribution of distribution data (content) to the display device 20 has been normally performed and the distribution summary is acquired as a distribution summary status. As the distribution status, as illustrated in FIG. 4, it is understood whether a content is assigned, the content has been distributed, whether the distribution of the content is successful/failed, whether the content is being distributed or not distributed from the distribution status.

A distribution summary status based on these distribution statuses is acquired. Here, to obtain the distribution summary status, it is desired to acquire the distribution summary status for each display device 20. The distribution status may be acquired from the display device 20 as appropriate or may be checked from the content distribution device 10.

The content summary is a summary for checking that a specific content (content folder, program, and the like) is assigned to the display device 20. For each content, a summary of the content-assigned display device 20 is acquired as a summary status.

This content summary may be acquired from the summary of the display device 20 based on the information on what is assigned. Therefore, not only the content, the content folder, and the program but also the summary status may be acquired for the information on the installation location and the like, for example.

The panel summary is a summary for checking the attribute and the like assigned to the panel. For each panel attribute, a summary of the display device 20 is acquired as a summary status. For example, as illustrated in FIG. 4, the attribute of the panel may indicate what type of display performance the display device 20 has and a distribution format or may be other contents such as resolution and whether touch is enabled or not.

Information (display device information) relating to the above-described display device may be acquired at any timing such as at a predetermined time interval (for example, every 5 minutes), at a predetermined time (for example, 2 a.m.), at timing with an operation command from an administrator, and when the status changes.

In addition, information on the display device at an acquired timing may be stored in the content distribution device 10 and the stored information may be used. In addition, for the distribution summary, the information is updated at the time of distribution, but for the panel summary, the timing may be different for each summary such as acquiring the information at the timing of displaying the summary.

Information on these display devices is stored and managed as panel management information 146.

Subsequently, each summary status tabulated in steps S102, S104, and S106 is displayed as a summary item for each item (step S108). For example, as the summary item of the distribution summary status, the number of panels in which there are items and the distribution status having the items (the number of items matching the distribution status) are displayed as “Assigned: 2 panels” and “Not Assigned: 3 panels”.

Subsequently, it is determined whether or not a summary item is selected (step S110). That is, it is determined whether the item displayed in step S108 has been selected by an administrator or the like.

In a case where a summary item is selected, a panel matching the selected item is extracted (step S110: Yes→step S112). For example, in a case where a portion displayed as “Assigned: 2 panels” is selected in the display of the distribution summary status, a panel (display device 20) whose distribution status is “Assigned” is extracted from the data stored in the panel management information 146.

If a summary item is not selected in step S110, it is determined whether or not a full display has been selected (step S110: No→step S114). The full display means displaying all of the panels managed by the content distribution device 10. In a case where the full display is selected, all of the panels managed by the content distribution device 10 are extracted (step S114: Yes→step S116).

In a case where the full display is not selected, the processing returns to step S110 (step S114: No). At this time, in a case where an operation for performing another processing (for example, creating a new content folder or the like) has been performed, different processing may be performed based on the operation specified by the operation.

Subsequently, the summary item displayed in step S108 is not displayed (step S118), and the panels extracted in step S112 or S116 are displayed in a list (step S120). In other words, among the panels managed by the content distribution device 10, panels that match the items that the operator/administrator wants to display or all of the panels to be managed are displayed in a list. In addition, information on a display device such as a panel ID and distribution status may be displayed on the list display. Hereinafter, an area displaying panels in a list is referred to as a panel list.

In the present embodiment, in order to display the panel list large, once the summary is not displayed, but the panel list may be displayed in a simplified manner, or a panel list with fewer items to be displayed may be displayed as summary items. In addition, the summary may be displayed as a separate display. For example, the summary display may be performed under the panel list or may be displayed in a separate window.

### 1.3.2 Content Distribution Processing

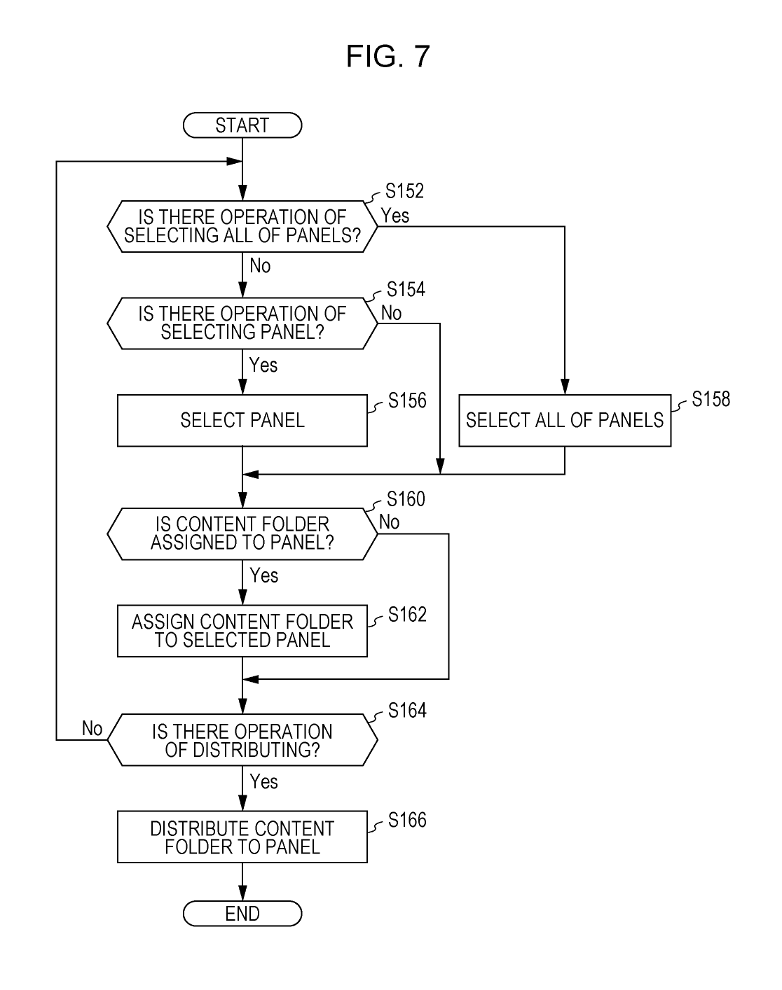

Next, the content distribution processing in the present embodiment will be described with reference to FIG. 7. The content distribution processing is processing performed after a list of extracted panels is displayed in the summary display processing described above and refers to processing of distributing a content to a panel desired by the operator/administrator. In addition, distribution of a content means distributing distribution data from the content distribution device 10, and the play list 1422, the program information 1424, the schedule information 1426, and the content 1442 are distributed to the panel specified as appropriate.

In the present embodiment, for the sake of convenience of description, a content folder will be described as an example to specify the distribution of a content, but the content file itself may be distributed or a program specified by the program or on may be distributed. In addition, these may be combined.

First, it is determined whether or not a panel selection operation has been performed (step S152). In a case where the panel selection operation has not been performed (step S152: No), it is determined whether the panel selection operation has been performed (step S154). That is, it is determined whether one or more panels included in the panel list have been selected. Here, in a case where the panel selection operation is performed, a panel is selected based on the selection operation (step S154: Yes→S156).

In addition, in step S152, in a case where all the panels have been selected (step S152: Yes), all the panels included in the panel list are selected (step S158).

The selected panel may be displayed by visually indicating that the panel is selected such as highlighting the panel ID, changing the background color of the area displaying information on the selected panel, and the like.

Subsequently, in a case where an operation to assign a content folder to a panel is performed (step S160: Yes), the content folder is assigned to the selected panel (step S162). This means that a display device (panel) for distributing a content folder is determined.

Various operations may be considered as an assignment operation, but for example, in a case where an operation of dragging a content folder and dropping the content folder to the selected panel is performed, it is determined that a content has been assigned to a panel. In addition, a panel may be assigned by using the setting screen of the content folder or a content folder may be assigned by using the setting screen of the panel.

In a case where no operation panel has been selected to assign a content folder and no panel is selected, the operation may be invalidated, and in a case where the dropped panel may be specified, it may be determined that a content has been assigned to the specified panel.

In a case where a content folder is assigned, the content assigned to the panel management information 146 is stored. For example, in a case where “NewContent” is newly assigned to a panel whose panel ID is “panel A”, data in which the panel ID is “panel A”, the assignment information is “NewContent”, and the distribution information is “Assigned” is stored in the panel management information 146. For the display schedule and the panel attribute, predetermined setting values are stored.

Subsequently, in a case where a distribution operation is performed (step S164: Yes), the content folder is distributed to the panel (S166). More specifically, the play list and the content specified by the content folder are distributed to the display device 20 from the content distribution device 10 as distribution data.

In addition, in a case where the distribution operation has not been performed (step S164: No), the processing may be returned from step S152 repeatedly or may be separately performed.

For example, the distribution operation may be performed only for the selected panel or may be performed for all the panels displayed in the list. In addition, a content to be distributed may be distributed only for the contents not distributed to a distribution destination of a panel.

### 1.4 Operation Example

### 1.4.1 Summary Display Processing

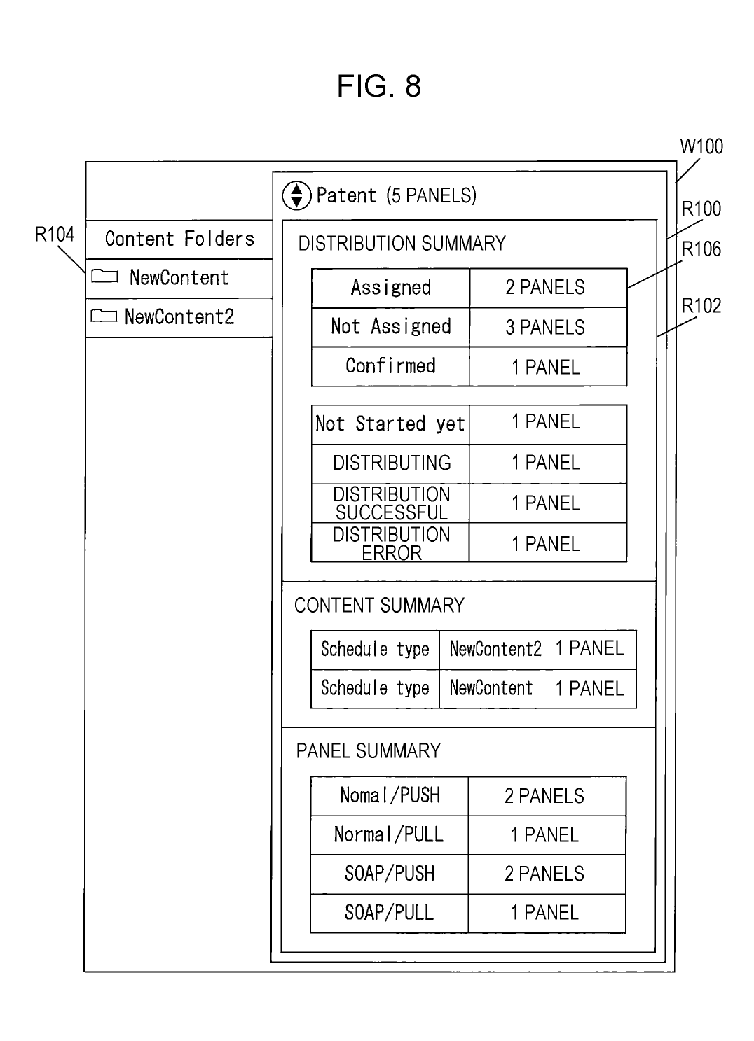

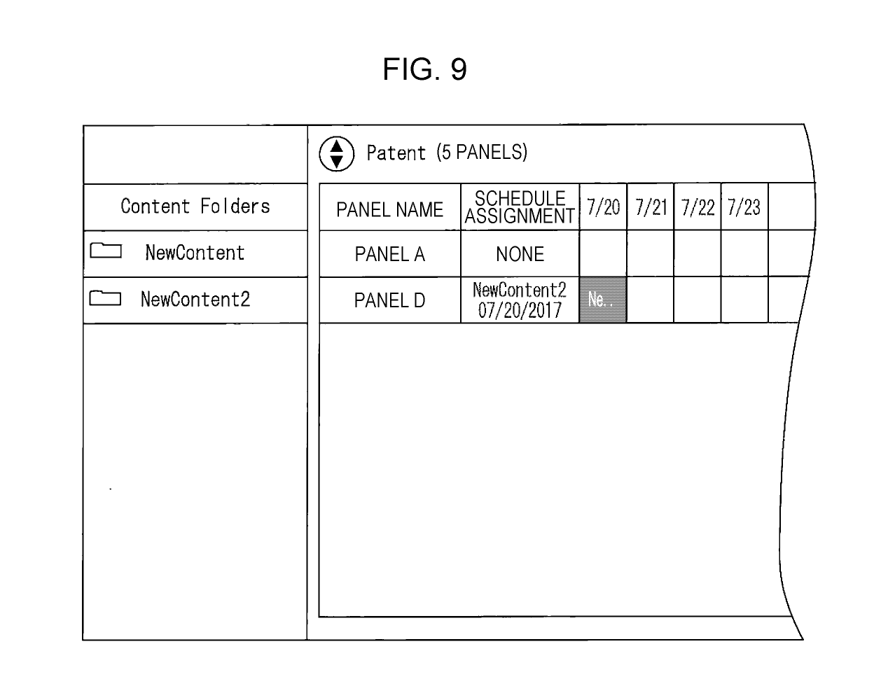

An example of the operation of the summary display processing will be described with reference to FIGS. 8 and 9. FIG. 8 illustrates an example of a display screen W100 when a summary item is displayed in step S108. First, each summary is displayed in an area R100. Here, a summary item is displayed for each group as indicated by an area R102. In the display screen W100, summary items are displayed in three groups but may be displayed in less or less than three groups. In addition, each group is displayed vertically but may be displayed horizontally. Furthermore, the summary items may not be displayed at all but may be partially displayed in a folded way or may be displayed in a scroll-down way.

In addition, on the left side of the display screen W100, a list of content folders is displayed in an area R104.

In addition, individual summary items are displayed in R106 in the summary items for each group indicated by the area R102. In this example, it is shoran that there are two panels in which contents are assigned (Assigned) as a distribution summary status.

FIG. 9 is a diagram illustrating an operation example when panels extracted by selecting summary items are displayed in a list in step S120 and illustrates an operation example when “Normal/PUSH” is selected from the panel summary status. On the right side of the screen are displayed the panel IDs of the two panels whose panel summary is “Normal/PUSH”, the status of schedule assignment, and the diagram visually illustrating the status of assignment.

The schedule assignment is information on the content folder or program information assigned to the panel, and the display schedule. In the example of FIG. 9, a panel D indicates that the play list specified by the content folder “NewContent2” is displayed on Jul. 20, 2017.

### 1.4.2 Content Distribution Processing

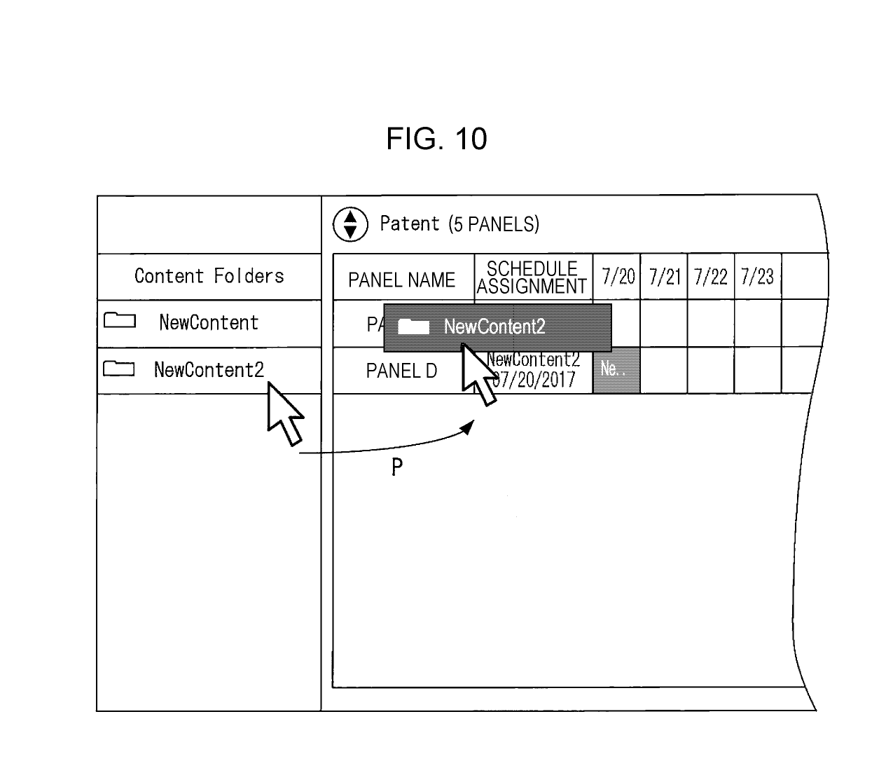

An operation example of content assignment included in content distribution processing will be described with reference to FIGS. 10 to 14.

FIG. 10 illustrates an operation example in a status in which the content folder “NewContent2” is dragged in a direction P from the list of content folders by a mouse operation. In the operation example of FIG. 10, “NewContent2” in a status of being dragged is expressed by displaying a rectangle with “NewContent2” written under a mouse cursor.

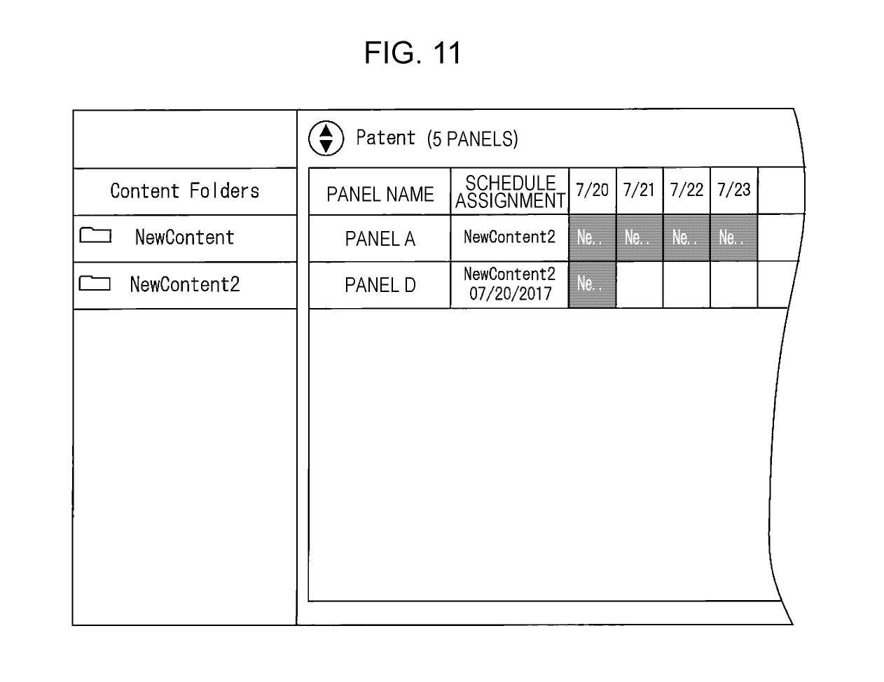

FIG. 11 illustrates an example of the operation after dropping the content folder “NewContent2” to the panel whose panel ID is “panel A” among the panels included in the panel list. By this operation, the content folder “NewContent2” is assigned to a panel whose panel ID is “panel A”.

In this operation example, the operation of selecting a panel is not performed, but since a panel may be specified from the dropped position, processing is performed by assuming that a content is assigned to the specified panel. In addition, a display schedule is not specified, and a panel whose panel ID is “Panel A” indicates that the content of the content folder “NewContent2” is displayed every day.

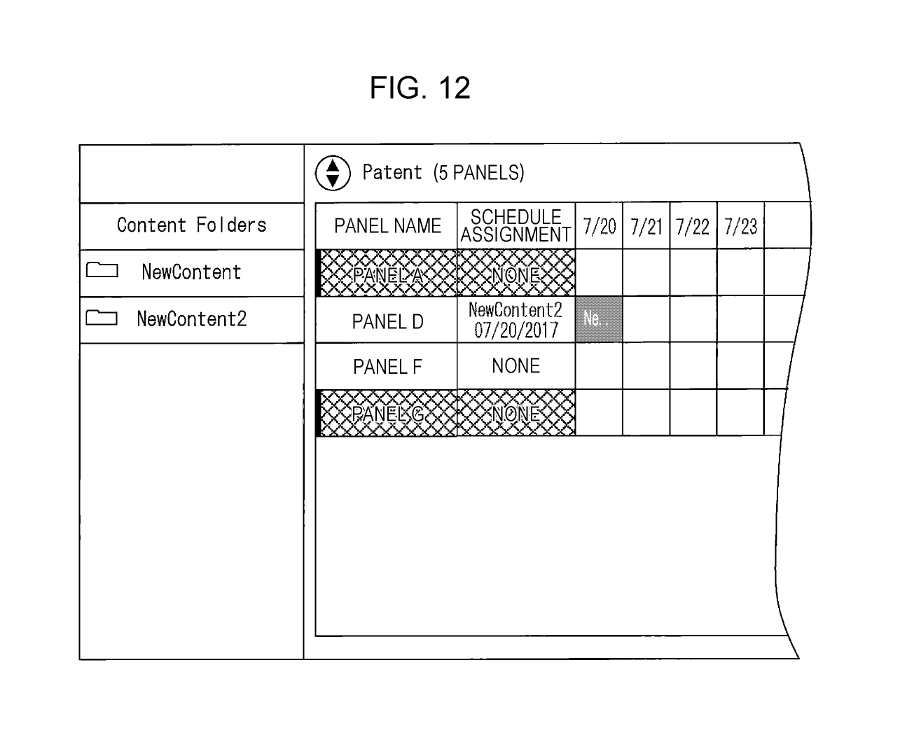

In addition, FIG. 12 illustrates a status in which “Panel A” and “Panel G” are selected. The operation example illustrated in FIG. 12 indicates that the panels are selected by displaying the background color and the thick line on the left side of the panel name.

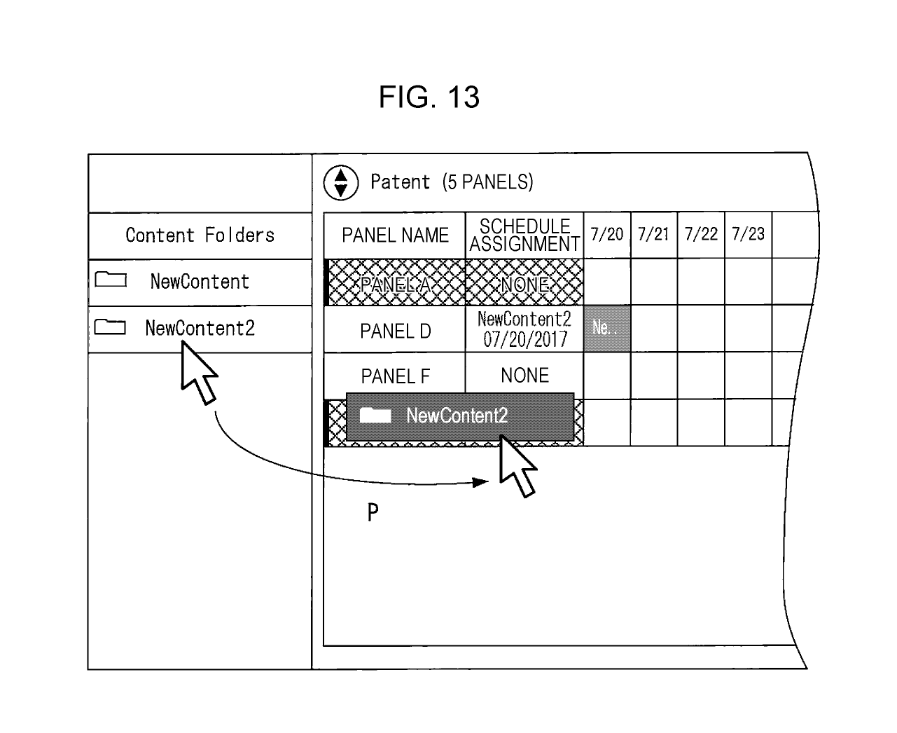

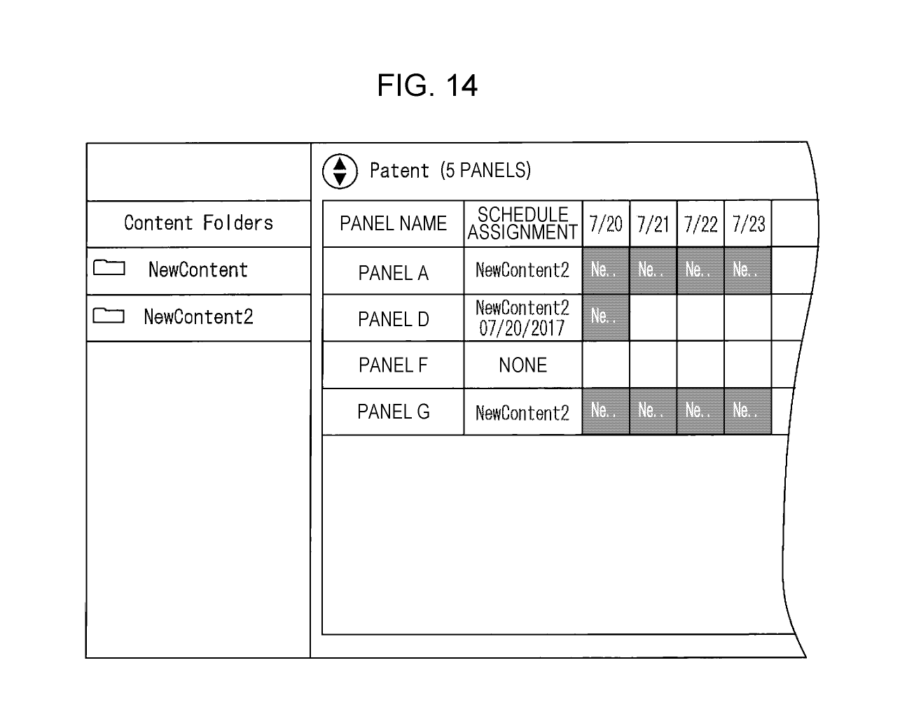

In addition, FIG. 13 illustrates an operation example in a status in which the content folder “NewContent2” is dragged in a direction P from the list of content folders by a mouse operation. In addition, FIG. 14 illustrates an example of an operation after dropping. By the series of operations from FIGS. 12 to 14, the content folder “NewContent2” is assigned to “Panel A” and “Panel G” selected in FIG. 12.

### 1.5 Screen Example

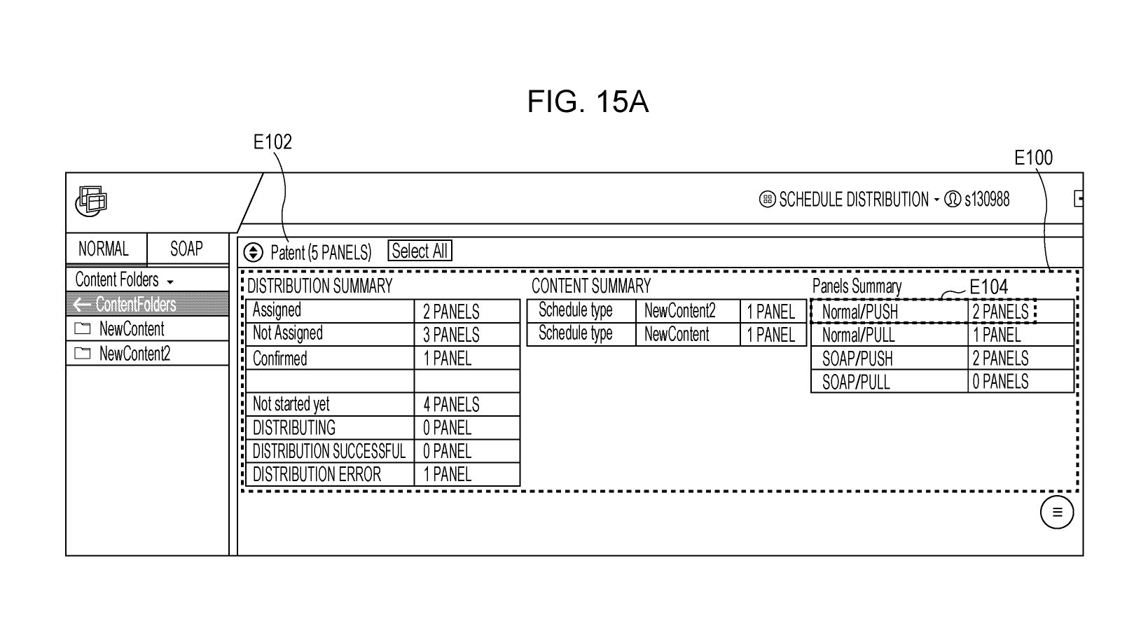

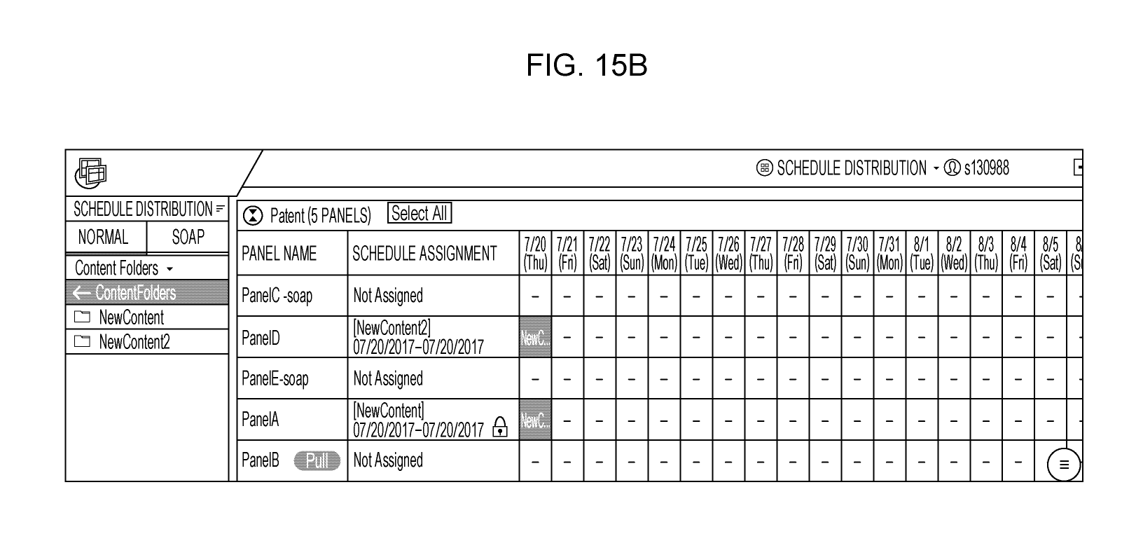

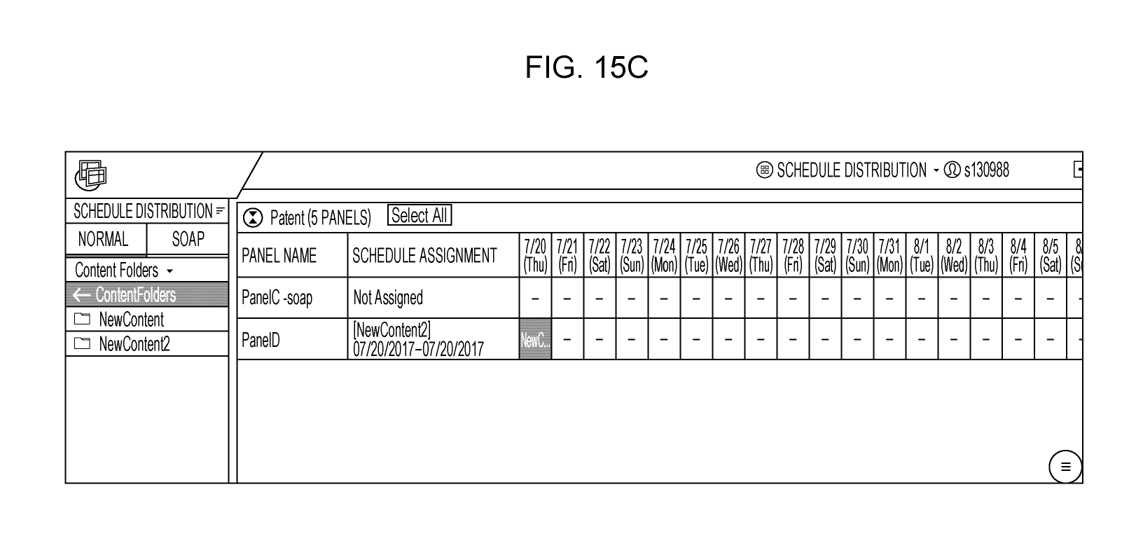

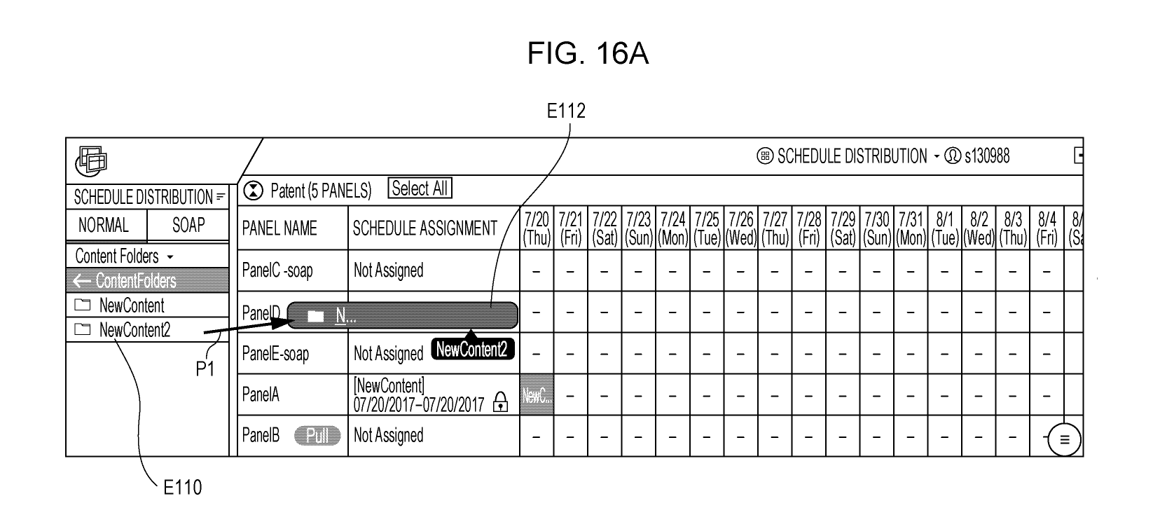

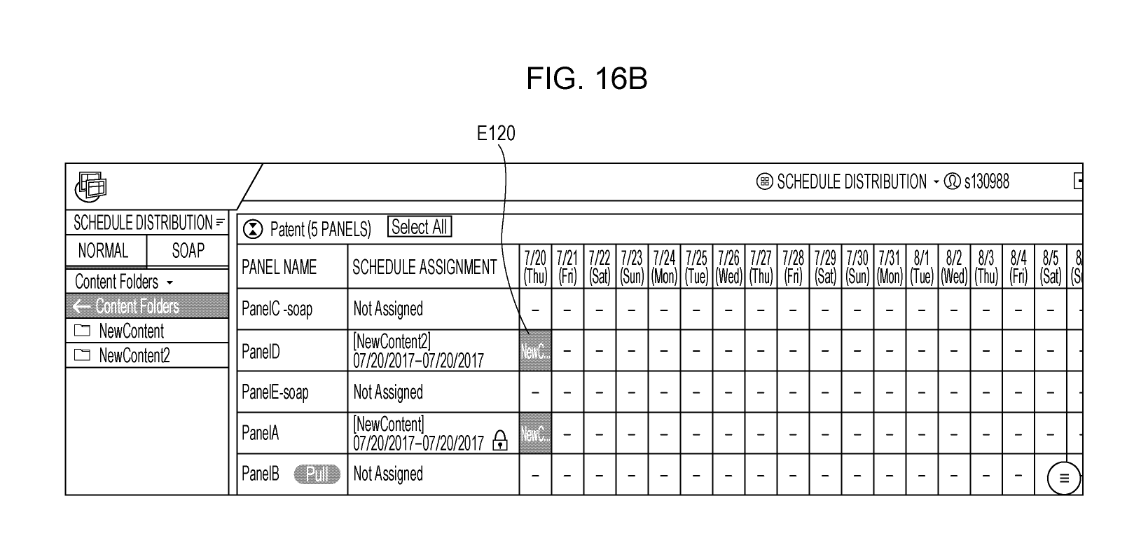

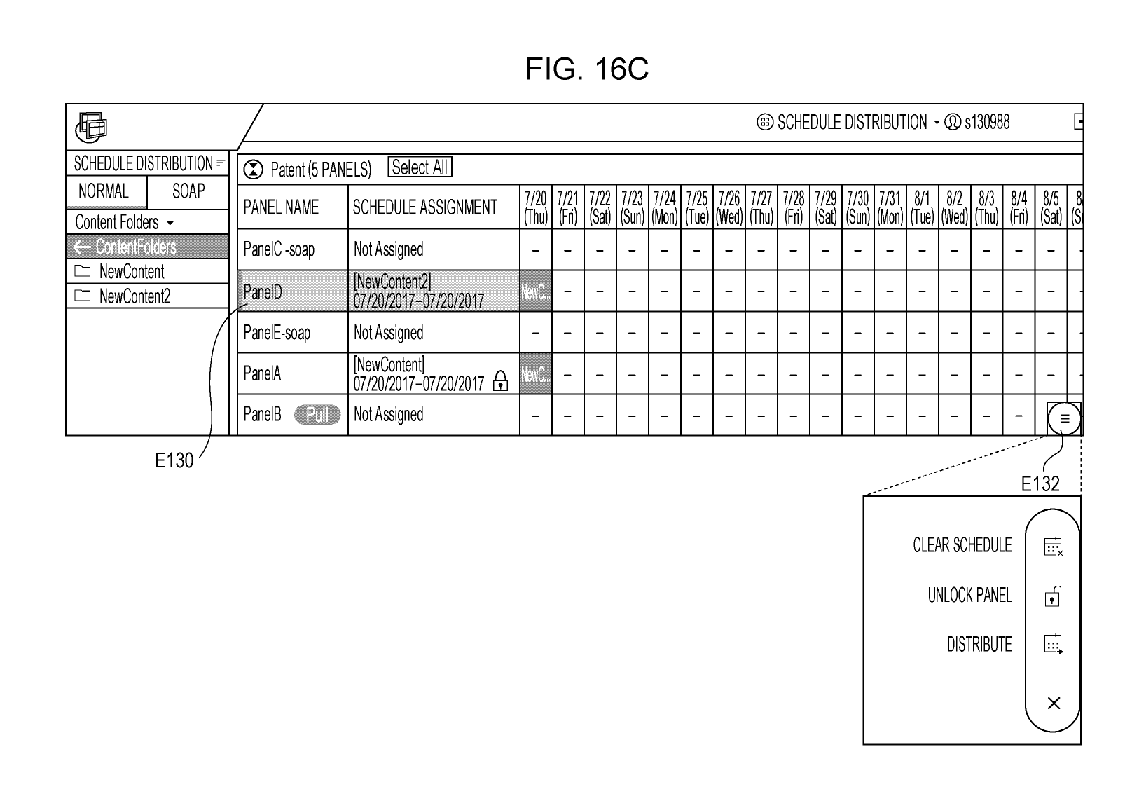

An example of a screen will be described with reference to FIGS. 15A to 16C. FIGS. 15A to 15C illustrate an example of the screen in the summary display processing. FIG. 15A is an example of a screen when a summary item is displayed in step S108. Here, E100 is an area for displaying the distribution summary status, the content summary status, and the panel summary status. In addition, E102 is an icon for performing the operation of selecting the full display, and E104 is a summary item.

FIG. 15B illustrates an example of a screen displayed when E102 is selected. In this example, all the panels managed by the content distribution device 10 (five panels in this example) are displayed. In addition, FIG. 15C illustrates an example of a screen displayed when E 104 is selected. In this example, among the panels managed by the content distribution device 10, panels whose panel summary is “Normal/PUSH” (two panels in this example) are displayed.

In addition, FIG. 16A to 16C illustrate an example of a screen in the case of assigning contents. FIG. 16A illustrates an example of a screen in a status in which the item (content folder “NewContent2”) of a content folder E110 is selected and dragged in a direction P1. At this time, a display E112 indicating a status of the content folder being dragged, and the name of the content folder being dragged is displayed in E112.

In addition, FIG. 16B is a screen example of a status in which the drop operation is performed in the status of FIG. 16A. By this operation, a content is assigned to a panel existing at a cursor position when a drop operation is performed. In addition, a result of the assignment of the content is expressed visually as indicated by E120. In the screen example illustrated in FIG. 16B, one day is specified as the display schedule.

FIG. 16C illustrates an example of a screen in status in which a panel is selected. As shown in E130, by displaying the background color and the thick line to the left of the panel name, thereby indicating that the panel is selected. In addition, processing other than content assignment may be performed on the selected panel. For example, as shown in E132, a button for displaying a menu may be provided, and processing (for example, clearing of assigned contents and the like) on the selected panel may be executed from the menu displayed by the operation on the button.

As described above, according to the present embodiment, with the summary display, it is possible to grasp the status of the panels managed by the content distribution device 10 from multiple viewpoints such as the distribution status of the content, the assigned content, and the status of the panel.

In addition, since it is possible to extract a panel matching the selected item by selecting a summary item, and further perform processing such as content distribution on the extracted panel, improvement of the convenience of management in the content distribution system may be expected.

In the above description, it is assumed that summary display is performed on all panels managed by the content distribution device 10, but the panels managed by the content distribution device 10 may be divided into one or more groups and summary display processing may be performed for each group. For example, the panels may be grouped by the area where the panels are installed or may be grouped by usage.

### 2. Second Embodiment

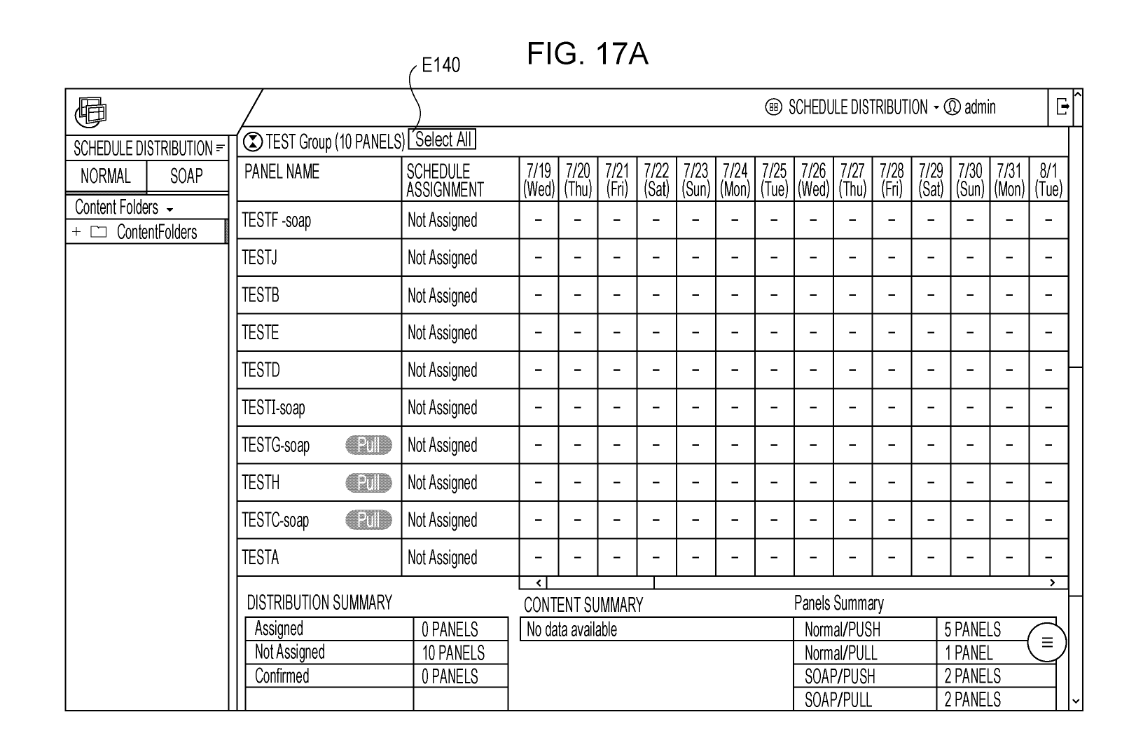

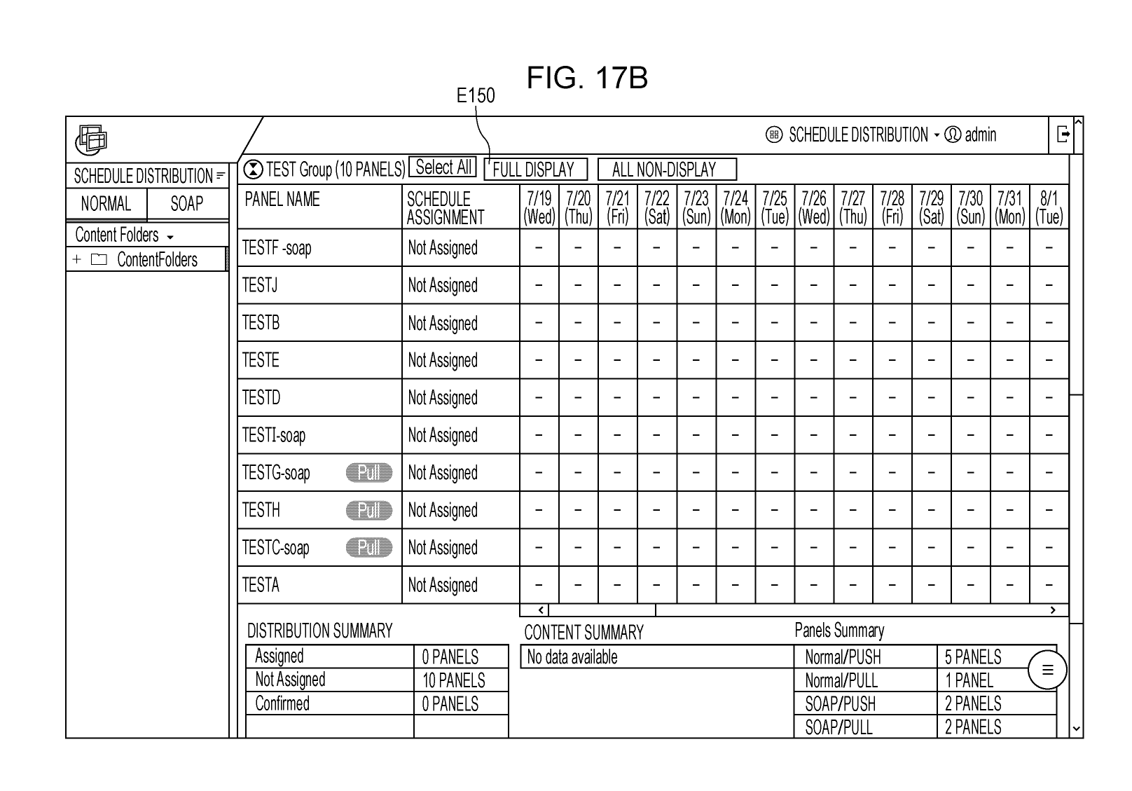

A second embodiment will be described with reference to FIGS. 17A and 17B. The second embodiment is an embodiment in which buttons for selecting panels and performing an operation relating to the panels to be displayed are displayed on a screen listing the panels extracted in step S120 of the first embodiment.

FIG. 17A is a screen example in which a button E140 with “Select All” written on the upper part of the screen displaying the list of panels is provided. By selecting the button E140, all the panels included in the panel list are selected.

In addition, FIG. 17B is a screen example in which a button labeled “Full Display” and a button labeled “All Non-display” are provided in the area indicated by E150 on the screen for displaying the panels. When the button labeled “Full Display” is selected, all the panels managed by the content distribution device 10 are displayed on the panel list irrespective of the panels extracted by selecting the summary item.

In addition, when a button labeled “All Non-display” is selected, all the panels displayed on the panel list are not displayed. In a case where additional information of the selected summary items is displayed below the panel list, when it is desired to quickly browse the additional information, it is effective to temporarily hide the panels in the panel list.

In addition to the above buttons, after displaying all the panels, a button for returning to the display of only the panels extracted by the selection of a summary item or a button for selecting only the panels (for example, a panel whose distribution status is “Not Assigned”) showing a specific status may be provided.

As described above, according to the present embodiment, it may be expected that panel management will be more efficient by providing buttons to assist operations after displaying the panel list.

### 3. Third Embodiment

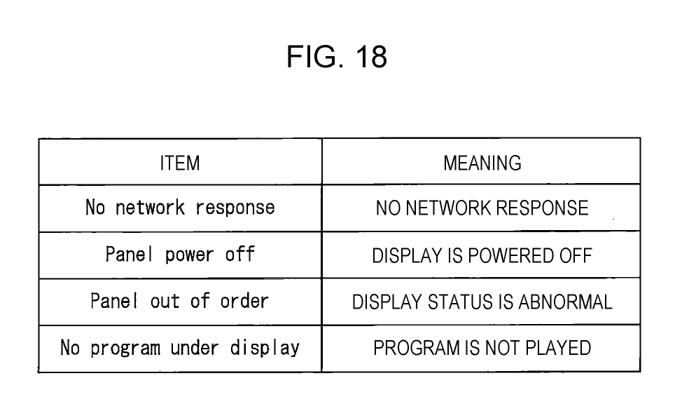

A third embodiment will be described with reference to FIGS. 18 to 23. The third embodiment is an embodiment in which summary display is performed according to the operation status of the panel and status monitoring is performed. That is, the operation status is included in the display device information that is information on the display device, and it is possible to issue an operation instruction to the display device in the operation status.

FIG. 18 is a table showing summary items relating to the status monitoring and the meanings thereof. For example, in a case where there is a panel whose item is “Panel Power Off”, it indicates that the power of the display of the panel is turned off. In this case, it is desired to perform control so that the power of the panel is turned on as appropriate.

For the summary information on the status monitoring, an attribute such as “operation status” may be added to the panel management information 146, and items of the table illustrated in FIG. 18 may be stored for the attribute. In addition, for example, polling is periodically (for example, every 10 seconds) performed from the content distribution device 10 to the display device 20 according to the instruction of the operator/administrator and update this item of the operation status based on the result.

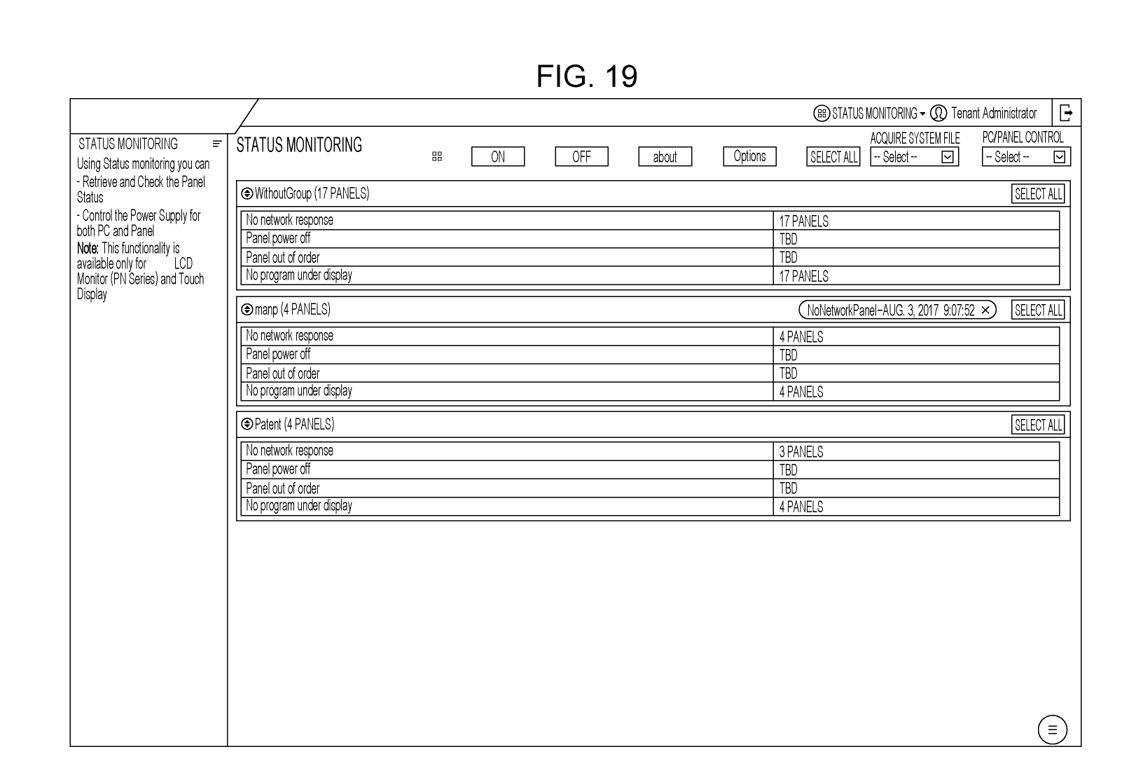

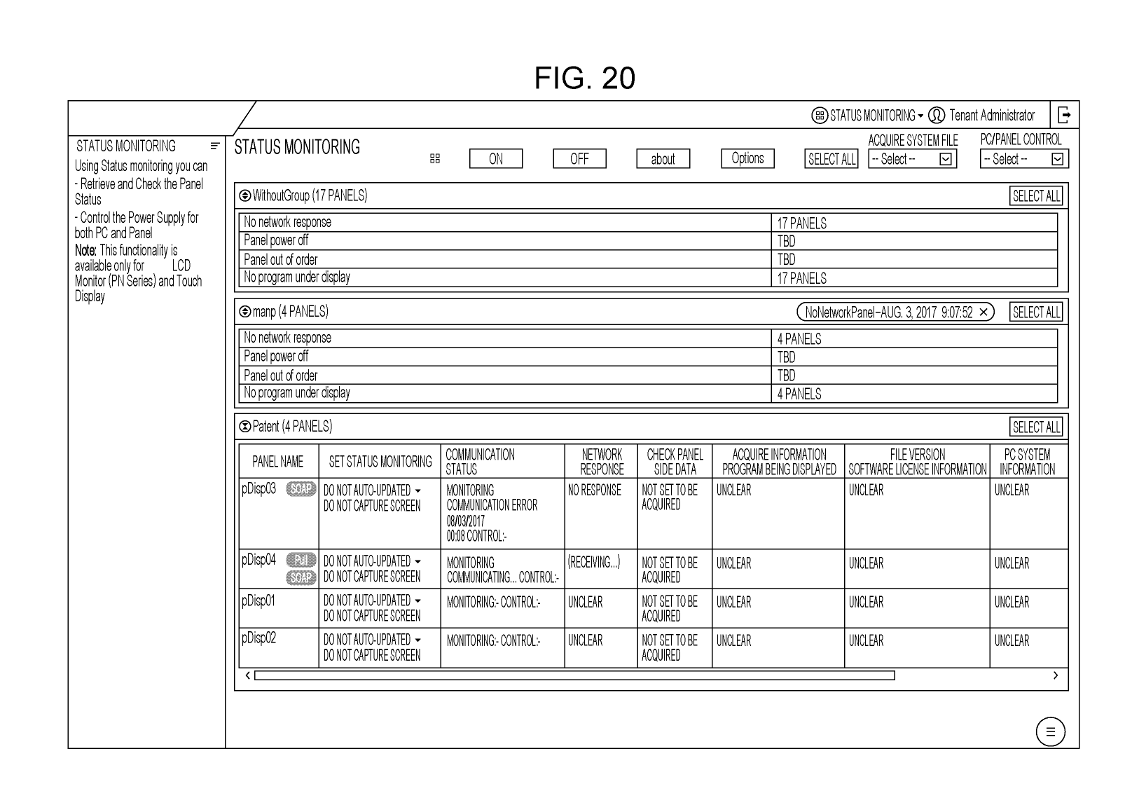

FIG. 19 illustrates an example of the screen in the summary display processing. In FIG. 19, the display devices 20 connected to the content distribution device 10 are divided into three groups and summary display is performed. That is, for each group, for each item illustrated in FIG. 18, the number of panels corresponding to the item is displayed. In addition, FIG. 20 is an example of a screen in which a panel matching the selected item is displayed on the panel list as a result of selecting one of the summary items.

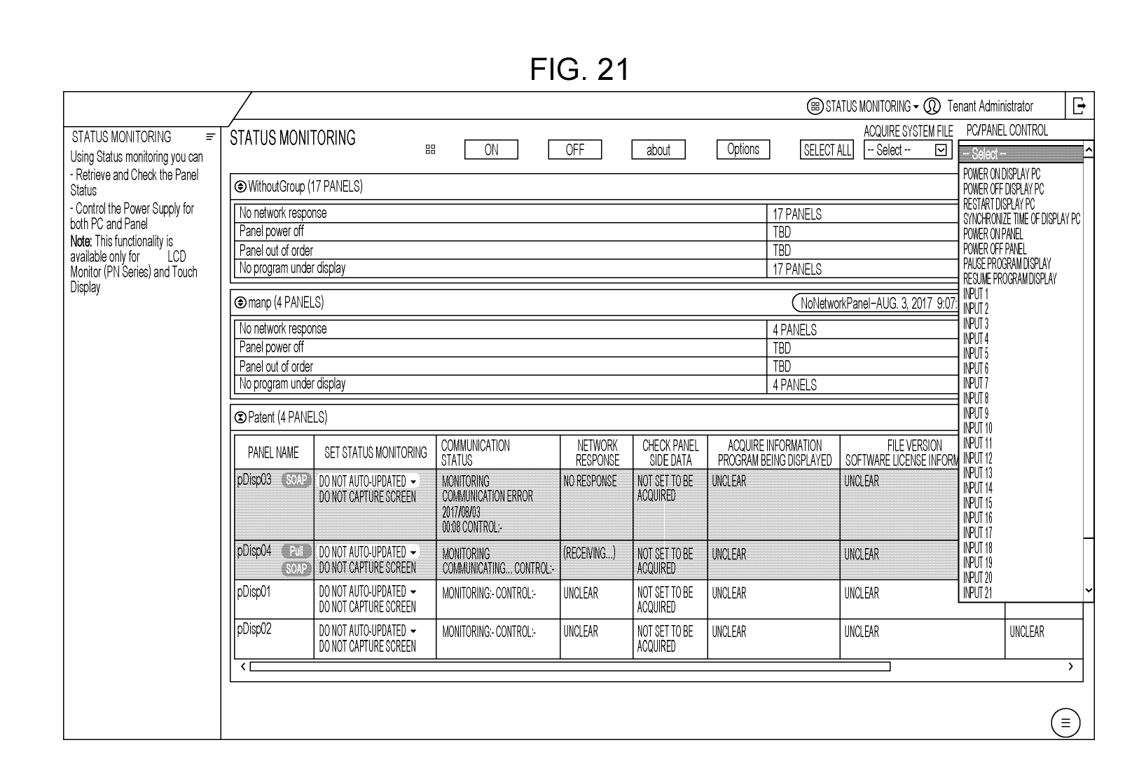

FIG. 21 illustrates an example of a screen in which two panels out of the four panels displayed in the panel list are selected and the menu of “PC Panel Control” is opened. In the menu of “PC Panel Control”, the controls to be performed on the panel are listed, and the control selected by the operator/administrator is executed for a previously selected panel. The control performed on the panel is, for example, “Synchronize Time of Display PC” or “Power On Panel”.

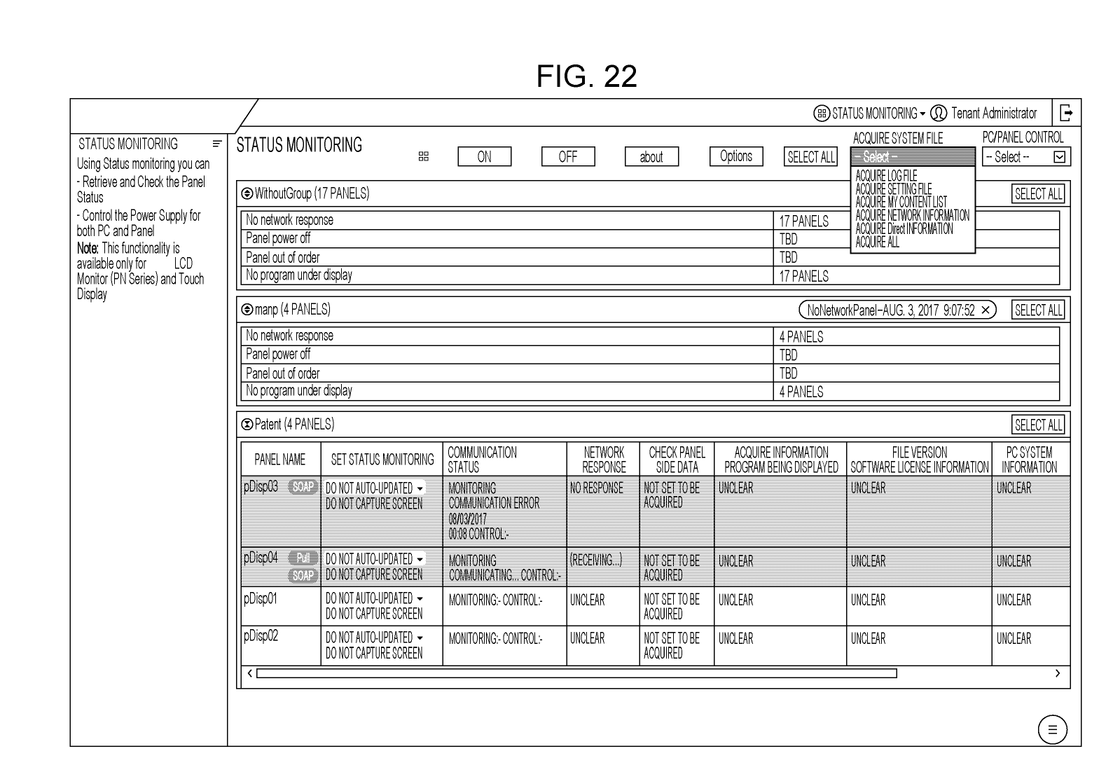

FIG. 22 illustrates an example of a screen in which two panels out of the four panels displayed in the panel list are selected and the menu of “Acquire System File” is opened. The system file is a file relating to the status of the panel and refers to a setting file or a log file stored for each panel.

In the “Acquire System File” menu, files acquired from the panel and files usable for a panel operation are listed. In addition, by selecting the system file displayed on the menu, the system file selected by the operator/administrator is acquired with respect to the panel selected in advance.

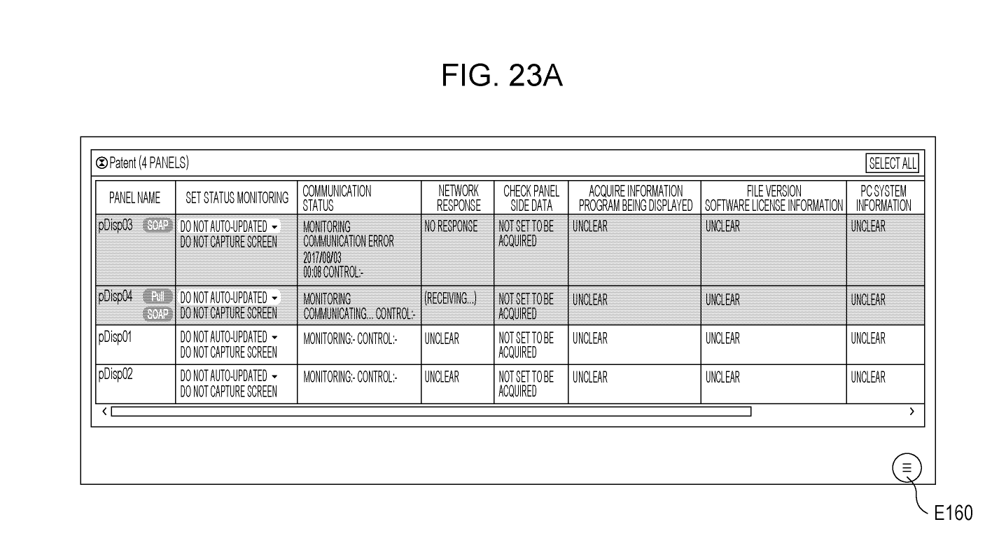

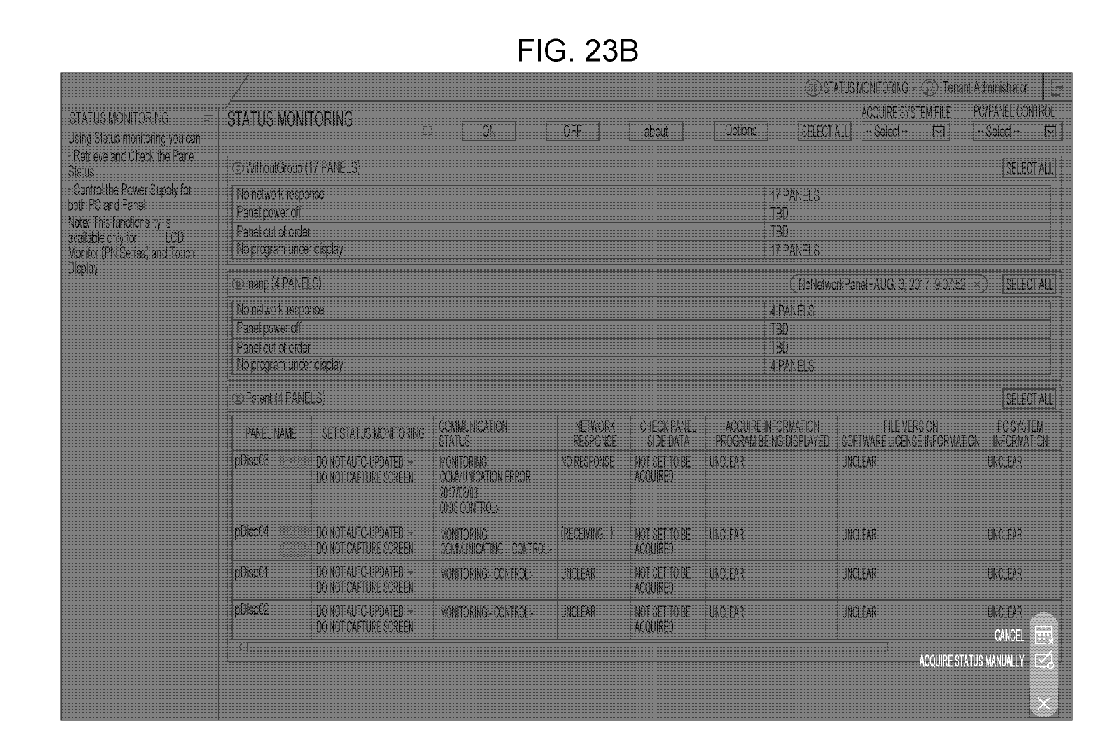

FIGS. 23A and 23B illustrate an example of a screen showing another method for controlling a panel. A button E160 in FIG. 23A is a button for opening a menu for selecting a control to be performed on the panel.

In addition, FIG. 23B illustrates a screen example in a case where the button E160 is selected. In FIG. 23B, a menu is displayed so as to overlap the button E160. In addition, by selecting an item from the menu, a control corresponding to the selected item of the menu is executed on the panel selected in advance.

As described above, according to the present embodiment, it is possible to improve the efficiency of the monitoring work of the signage system by summarizing the operation status of the panel. In addition, it is possible to perform a control by a simple operation on a panel on which a desired operation is performed, and therefore it is possible to normalize the panel promptly.

### 4. Modification Example

The embodiments of the present disclosure have been described in detail with reference to the drawings, but the specific configuration is not limited to this embodiment, and designs and the like within the scope not deviating from the gist of the present disclosure are also included in the scope of the claims.

For the sake of convenience of description, each embodiment has been described separately for the purpose of description, but it is possible to combine and execute the embodiments within a possible range. For example, it may be expected to improve efficiency and convenience for content distribution and monitoring work by combining the first embodiment and the third embodiment.

In addition, in the embodiments, a program operating on each device is a program (a program that enables a computer to function) for controlling a CPU or the like so as to realize the functions of the above-described embodiments. Information handled by these devices is temporarily stored in a temporary storage device (for example, RAM) at the time of processing, then stored in the storage devices of various ROMs, HDDs, and SSDs, and read, modified and written by the CPU as appropriate.

In addition, in the case of distributing to the market, the program may be stored in a portable storage medium and distributed or transferred to a server computer connected via a network such as the Internet. In this case, of course, the storage device of the server computer is also included in the present disclosure.

The present disclosure contains subject matter related to that disclosed in Japanese Priority Patent Application JP 2017-161406 filed in the Japan Patent Office on Aug. 24, 2017, the entire contents Of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A content distribution device connectable to one or more display devices that display a content, the content distribution device comprising:
a display-device-information management unit that manages display device information on the one or more display devices connected to the content distribution device;
a summary information generation unit that generates summary information based on the display device information on the one or more display devices;
a display unit that displays the summary information;
a display device extraction unit that extracts one or more display devices corresponding to selected summary information in a case where the displayed summary information is selected;
a distribution destination determination unit that determines a display device to be a distribution destination of the content from the one or more display devices extracted by the display device extraction unit; and
a content distribution unit that distributes the content to the display device determined by the distribution destination determination unit.

2. The content distribution device according to claim 1, further comprising:
a list display unit that displays a list of the one or more display devices extracted by the display device extraction unit,
wherein the distribution destination determination unit selects and determines a display device to be a distribution destination from the list of the one or more display devices.

3. The content distribution device according to claim 1,
wherein the display unit displays a number of the one or more display devices corresponding to the summary information for each piece of the summary information, and
the list display unit displays the list of the one or more display devices extracted by the display device extraction unit when the displayed number of the one or more display devices is selected.

4. The content distribution device according to claim 2,
wherein the display unit displays a specific display for performing a full display, and
the list display unit displays a list of all the connected display devices when the specific display is selected.

5. The content distribution device according to claim 2, further comprising:
a content management unit that manages, as a content folder, the content distributed to the one or more display devices,
wherein the distribution destination determination unit determines a display device to be a distribution destination when a folder display being displayed for specifying the content folder is dragged and dropped from the list of the one or more display devices to the display device to be the distribution destination.

6. The content distribution device according to claim 5, further comprising:
a selection unit that selects one or more display devices from the list of the one or more display devices,
wherein the distribution destination determination unit determines a display device to be a distribution destination by dropping the folder display to the one or more display device selected by the selection unit.

7. The content distribution device according to claim 5,
wherein the content management unit further manages display schedule information for displaying the content on the one or more display devices.

8. The content distribution device according to claim 7,
wherein the list display unit displays the one or more display devices together with a schedule of the content to be distributed to the one or more display devices, and
the folder display is reflected and displayed on the schedule of the one or more display devices based on the display schedule information by dropping the folder display to the selected one or more display devices.

9. The content distribution device according to claim 8,
wherein the selection unit identifies and displays the selected one or more display devices.

10. The content distribution device according to claim 1,
wherein the display device information is at least any one of a content distribution status for a display device, a display device to which the content is assigned, an attribute of a display device, and a status of a display device.

11. The content distribution device according to claim 1,
wherein the display-device-information management unit acquires the display device information from a display device at predetermined time intervals or acquires the display device information from the display device when an acquisition operation is performed.

12. The content distribution device according to claim 1, further comprising:
a control signal transmission unit that transmits a control signal for controlling a display device to the display device determined by the distribution destination determination unit.

13. A content distribution system comprising:
one or more display devices; and
a content distribution device,
wherein the content distribution device includes
a display-device-information management unit that manages display device information on the one or more display devices connected to the content distribution device,
a summary information generation unit that generates summary information based on the display device information,
a display unit that displays the summary information,
a display device extraction unit that extracts one or more display devices corresponding to selected summary information in a case where the displayed summary information is selected,
a distribution destination determination unit that determines a display device to be a distribution destination of the content from the one or more display devices extracted by the display device extraction unit, and
a content distribution unit that distributes the content to the display device determined by the distribution destination determination unit, and
wherein each of the one or more display devices includes
a content reception unit that receives the content distributed from the content distribution device, and
a content display unit that displays the received content.

14. A non-transitory storage medium storing a program causing a computer connectable to one or more display devices that display a content, to execute:
a display-device-information management function of managing display device information on the one or more display devices connected to the content distribution device;
a summary information generation function of generating summary information based on the display device information on the one or more display devices;
a display function of displaying the summary information;
a display device extraction function of extracting one or more display devices corresponding to selected summary information in a case where the displayed summary information is selected;
a distribution destination determination function of determining a display device to be a distribution destination of the content from the one or more display devices extracted by the display device extraction function; and
a content distribution function of distributing the content to the display device determined by the distribution destination determination function.
